(19) United States
(12) Patent Application Publication
(10) Pub. No.: US 2010/0099590 A1
(43) Pub. Date: Apr. 22, 2010

(54) Oil dispersible polymer nanoparticles

(76) Inventor: Guojun Liu, Kingston (CA)

Correspondence Address: GOWLING LAFLEUR HENDERSON LLP, SUITE 1600, 1 FIRST CANADIAN PLACE, 100 KING STREET WEST, TORONTO, ON, M5X 1G5, CA

(21) Appl. No.: 11/637,193

(22) Filed: Dec. 12, 2006

Related U.S. Application Data
(60) Provisional application No. 60/749,080, filed on Dec. 12, 2005.

(51) Int. Cl. C10L 1/18; B32B 1/00

(52) U.S. Cl. 508/478; 428/407; 977/773; 977/902

(57) ABSTRACT

There is disclosed an oil-dispersible nanoparticle comprising metal-binding functional groups on its surface. Preferably, the nanoparticle is derived from substantially spherical polymer micelles of (A_{1-y}C_{y})ₙBₘ diblocks or (A_{1-y}C_{y})ₙBₘ(A_{1-y}C_{y})ₙ triblocks. A method for producing the nanoparticles is also described. The nanoparticles are particularly useful as lubricant additives.

### CROSS-REFERENCE TO RELATED APPLICATION

The present application claims the benefit under 35 U.S.C. §119(e) of provisional patent application Ser. No. 60/749,080, filed Dec. 12, 2005, the contents of which are hereby incorporated by reference.

### BACKGROUND OF THE INVENTION

1. Field of the Invention

This invention relates to oil-dispersible polymer nanoparticles and methods for preparing such compositions. The invention further relates to uses of such nanoparticles, such as oil additives to reduce friction and wear. The invention further relates to oil-dispersible nanospheres and methods for making and using them.

2. Description of the Prior Art

Polymer nanospheres can be prepared by different techniques. They can be prepared starting from monomers via techniques such as emulsion polymerization, mini-emulsion polymerization, micro-emulsion polymerization, inverse emulsion polymerization, dispersion polymerization, and precipitation polymerization. They can also be prepared from pre-formed polymers via their dispersion by emulsion processes or from block copolymers by micellization and then chemical processing of the resultant micelles. Polymer nanospheres are useful in many applications, including as binders in paints, paper coating, and tire manufacturing, and as toughing agents in rubber-toughened plastics, in pressure-sensitive adhesives, and in medical diagnostics. To date, there has been no description of use of polymer nanoparticles as an additive component of lubricating oils that acts as a friction modifier and/or anti-wear agent.

Current friction modifiers in engine oils of automobiles are surfactant based. One such example is glyceryl monolaurate, where the hydrophobic laurate tail stretches into the oil phase and the polar two hydroxyl groups of the glyceryl moiety enable the binding of the molecule to the surface of a metal part, i.e., a piston ring or a cylinder in an automobile engine. A densely packed film of such surfactant provides friction reduction in the boundary lubrication (BL) regime where the asperities of the moving metal surfaces are in partial or extensive contact for two mechanisms. First, the adsorbed film is more readily sheared off from a surface than metal and can reform on the metal surfaces once the moving parts are away from one another. Second, the adsorbed films normally repel one another, as has been demonstrated for polymer brushes formed on sliding mica surfaces—see, for example, Klein, J.; Kumacheva, E.; Mahalu, D.; Perahia, D.; Fetters, L. J. Nature 1994, 370, 634-636.

An adsorbed nanosphere or nanolog layer might work significantly better than a surfactant layer, because a third and potentially more effective friction reduction mechanism may become operative. This is the ball-bearing mechanism, which involves the rolling of the nanospheres or nanologs between two sliding surfaces and the conversion of sliding friction to rolling friction. A nanoparticle layer may also work better as an anti-wear agent for the reduced contact or greater distance that the nanoparticles provide between the moving metal surfaces.

There are various reports addressing the advantages of nanoparticles in providing friction reduction and anti-wear. Previously used nanoparticles were mainly inorganic in composition including fullerenes or buckyballs. Bardahl Additives & Lubricants reports that the presence of buckyballs (C₆₀ and C₇₀) in their Kiwami engine oil and fuel system treatment helps reduce friction between automobile engine parts and thus increases fuel efficiency—see, for example, http://www.bardahl.com. Valvoline uses titanium oxide nanoparticles in their Nanowax® formulation for car polishing—see, for example, http://www.valvoline.com. Exxon Research and Engineering Company holds a patent on the use of fullerene-grafted polymers as an additive to lubricating oils—see U.S. Pat. No. 5,292,444 (based on application number 955,627).

Researchers have also explored the use as friction modifiers of WS₂ (Stipanovic, A. J.; Schoonmaker, J. P. SAE Technical Paper 932779), MoS₂ (Zhang, Z. J.; Xue, Q. J.; Zhang, J. Wear 1997, 209, 8-12) and organomolybdenum (Rappoport, L.; Fleischer, N.; Tenne, R. Adv. Mater. 2003, 15, 651-655) nanoclusters as well as graphite (Street, K. W.; Marchetti, M.; Vander Wal, R. L.; Tomasek, A. J. Tribol. Lett. 2004, 16, 143-149), silver (Chinas-Castillo, F.; Spikes, H. A. Trans. ASME 2003, 125, 552-557), gold (Chinas-Castillo, F.; Spikes, H. A. Trans. ASME 2003, 125, 552-557), copper (Zhou, J. F.; Wu, Z. S.; Zhang, Z. J.; Liu, W. M.; Xue, Q. J. Tribol. Lett. 2000, 8, 213-218), bismuth (Zhao, Y. B.; Zhang, Z. J.; Dang, H. X. Mater. Lett. 2004, 58, 790-793) and titanium oxide (Hu, Z. S.; Dong, J. X. Wear 1998, 216, 92-92) nanoparticles. However, not all studies have been systematic and the results reported by different groups have often contradicted one another. Buckyballs, for example, have diameters ranging between 0.4 and 1.6 nm (Goel, A.; Howard, J. B.; Sande, J. B. V. Carbon 2004, 42, 1907) and have been claimed to be effective in reducing friction by some groups and claimed to be ineffective by others. In hindsight this can be explained by the different surfaces tested. When the tested surfaces are highly polished and the root-mean-square roughness of the tested surfaces is smaller than the diameter of the buckyballs, a friction reduction effect should have been observed. Such an effect should diminish or vanish when rougher testing surfaces are used. The fact that this relationship between nanoparticle size/surface roughness and friction performance was not fully appreciated in the past has lead to confusing and misleading conclusions from different groups. Other types of inorganic nanoclusters reported in the past also often had non-uniform size distributions. When used as additives in oil, they often had dispersion problems. These factors have also introduced uncertainties in the reports.

### SUMMARY OF THE INVENTION

It is an object of the present invention to obviate or mitigate at least one of the above-mentioned disadvantages of the prior art.

It is another object of the present invention to provide a novel oil-dispersible nanoparticle.

It is another object of the present invention to provide a novel method for making an oil-dispersible nanoparticle.

It is yet another object of the present invention to provide a novel method for reducing friction between moving parts.

Accordingly, in one of its aspects, the present invention provides polymer nanoparticles and methods for preparing and using such compositions. The nanoparticles may be, for example, nanospheres, nanologs or nanocylinders. The invention further provides oil-dispersible nanoparticles and methods of using such nanoparticles as oil additives to reduce friction and wear. Advantageously, the oil-soluble nanoparticles are made by a method which enables more effective control of particle size and properties.

In a first aspect, the invention provides an oil-dispersible nanoparticle comprising metal-binding functional groups on its surface. The average hydrodynamic diameter of the nanoparticle may range from about 20 to about 250 nm, preferably about 20 to about 100 nm. The nanoparticle may comprise a core that is substantially insoluble in oil, and a corona that is oil soluble. The diameter of the core may range from about 10 to about 150 nm, and is preferably between about 10 to about 80 nm. The core may be crosslinkable, optionally photo-crosslinkable. The nanoparticle may be substantially spherical.

In a second aspect, the invention provides a method for making an oil-dispersible nanoparticle comprising 1) forming substantially spherical or cylindrical micelles of (A_{100%-y}C_{y})ₙBₘ diblocks or (A_{100%-y}C_{y})ₙBₘ(A_{100%-y}C_{y})ₙ triblocks in a block-selective solvent, and, optionally, 2) crosslinking the substantially spherical or cylindrical micelles, where the A units are oil soluble monomers; the C units are functional groups that are metal binding or metal binding after chemical transformation; and the B units are oil insoluble monomers and preferably crosslinkable; where y ranges from 0 to about 30%, preferably from 0 to about 5% and more preferably from about 0.1% to about 2%; where n ranges from about 10 to about 10,000; and where m ranges from about 10 to about 10,000. The oil insoluble monomers in the B units can be a single type of monomer (in which case the result is a homopolymer block) or a mixture of monomers may be used (in which case the result is a copolymer block).

Generally, it is preferred that the block copolymer of the micelles has the following formula:

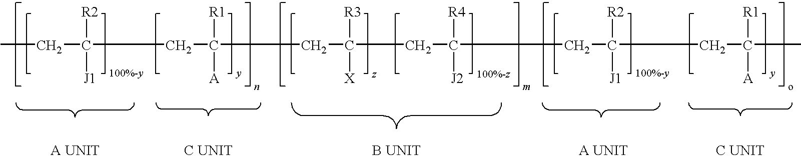

wherein:

R1, R2, R3 and R4 are independently hydrogen or a C₁-C₆ alkyl group;

J1 and J2 are the same or different and each is an alkylphenyl group or alkylcarboxyl group;

A is an anchoring or hook group;

X is a cross-linkable oil insoluble moiety;

y is 0 to 30%;

z is 5 to 100%;

m and n are the same or different and each is an integer in the range of 10 to 10,000; and

o is an integer in the range of 0 to 10,000.

Preferably, R1, R2, R3 and R4 are independently hydrogen or a methyl group. More preferably, R1, R2, R3 and R4 each are hydrogen.

Preferably, J1 and J2 are the same or different and each is selected from the group consisting of alkylphenyl or alkylcarboxyl. The alkyl groups in J1 can be either linear or branched having 1 to 30 carbon atoms, preferably having 4 to 18 carbon atoms, and more preferably having 6 to 10 carbon atoms. The alkyl groups in J2 can be either linear or branched having 1 to 30 carbon atoms, preferably having 1 to 10 carbon atoms, and more preferably having 1 to 8 carbon atoms.

Preferably, moiety A of the C unit is selected from the group consisting of hydroxyl, amino, carboxyl, carboxyphenyl (where the carboxyl group can be at the para, meta, or ortho position), pyridyl, aminoalkylphenyl, carboxyalkylphenyl, N-alkylcarbamoyl, N,N-dialkylcarbamoyl, glycerylcarboxyl, hydroxyalkylcarboxyl (e.g, 2-hydroxyethylcarboxyl), imidazolyl, triazolyl and the like.

Preferably, X of the B unit is selected from the group consisting of hydroxyl, amino, carboxyl, carboxyphenyl (where the carboxyl group can be at the para, meta, or ortho position), pyridyl, aminoalkylphenyl, carboxyalkylphenyl, glycerylcarboxyl, hydroxyalkylcarboxyl (e.g, 2-hydroxyethylcarboxyl), cinnamoyloxyalkylcarboxyl (e.g., 2-cinnamoyloxyethylcarboxyl), allylcarboxyl, acryloxyalkylcarboxyl (e.g., 2-acryloxyethylcarboxyl) and the like.

Preferably, y is 0 to 5%, particularly when C unit is selected from a monomer containing carboxyl groups, amino groups, pyridyl groups, carbonyl groups, hydroxyl groups, sulfonyl groups, sulfate groups, phosphine groups, phosphate groups and sulfide groups. They value may increase to 30% if C unit is selected from a monomer containing triazole, indole, imidazole and other less polar metal-binding groups. When the present nanoparticle is used in an engine oil application, the use of phosphorus-containing moieties may be less preferred owing to potential interference with the catalyst used in the emission control system.

Preferably, m and n are the same or different and each is an integer in the range of 10 to 500.

Preferably, o is an integer in the range of 0 to 500.

If the resultant nanoparticle composition is to be used as an engine oil additive, in certain cases it is possible to conduct the method for producing the nanoparticle composition in an engine oil composition.

The A units may be selected from poly(alkyl acrylate), poly(alkyl methacrylate), poly(dimethyl siloxane), polyisoprene, poly(butadiene), poly(isobutylene), poly(alkylstyrene) (e.g., poly(t-butylstyrene) and combinations thereof. The alkyl units may be selected from C₁ to C₂₀, preferably from C₄ to C₁₈. The alkyl units may be butyl, 2-ethylhexyl or a combination thereof.

The C units may be selected from monomers containing carboxyl groups, amino groups, pyridyl groups, carbonyl groups, hydroxyl groups, sulfonyl groups, sulfate groups, phosphine groups, phosphate groups, sulfide groups, triazole groups, indole groups and combinations thereof.

The B units may be selected from poly(vinyl pyridine), poly(2-cinnamoyloxyethyl methacrylate), poly(2-cinnamoyloxyethyl acrylate), poly(2-hydroxyethyl acrylate), poly(2-hydroxyethyl methacrylate), polyisoprene, poly(allyl acrylate), poly(allyl methacrylate), poly(2-acryloxyethylacrylate), poly(2-acryloxymethacrylate), polybutadiene, poly[2-(dimethylamino)ethyl methacrylate], poly(acrylic acid), poly(methacrylic acid), poly(vinyl alcohol), and combinations thereof.

In a third aspect, the invention provides a method of reducing friction comprising providing an oil-dispersible nanoparticle as an additive to an oil employed for lubrication.

In a fourth aspect, the invention provides a method of reducing wear of machine parts comprising providing an oil-dispersible nanoparticle as an additive of an oil contacting said machine parts.

Exemplary embodiments described herein provide oil-soluble nanoparticles and methods of making oil-soluble nanoparticles. Accordingly to a said embodiment, an oil-soluble nanoparticle includes a photo-crosslinkable core derived from a reaction product of poly(2-hydroxyalkyl acrylate) and cinnamoyl chloride. The core is substantially surrounded by an oil-soluble corona made of poly[(2-ethylalkyl acrylate)-ran-(alkyl acrylate)].

In another embodiment there is provided a method of making an oil-soluble nanoparticle. The method includes hydrolyzing a block copolymer having a poly(2-alkylalkyl acrylate)-ran-(alkyl acrylate) block (e.g., a t-butyl acrylate block) and a poly(2-trialkylsiloxyethyl acrylate) block (e.g., a 2-trimethylsiloxyethyl acrylate block) in aqueous tetrahydrofuran using acetic acid. A first portion of the hydrolyzed poly(2-hydroxyethyl acrylate) or PHEA block is cinnamated with cinnamoyl chloride in pyridine to provide crosslinkable 2-cinnamoyloxyethyl acrylate units. A second portion of the hydrolyzed PHEA block is reacted with octanoyl chloride to provide a poly[(2-cinnamoylethyl acrylate)-ran-(2-octanoylethyl acrylate)] block.

### BRIEF DESCRIPTION OF THE DRAWINGS

Embodiments of the present invention will be described with reference to the accompanying drawings, wherein like reference numerals denote like parts, and in which:

FIG. 1 shows transmission electron microscopy (TEM) images of nanosphere samples 1-1F1 and 1-2F1;

FIG. 2 is a graph showing the degree of tBA hydrolysis as a function of hydrolysis time for a nanosphere sample with 6 mol % of tBA;

FIG. 3 is a graph showing variation in the hydrodynamic diameters dₕ of the 1-1F1 spheres in EHC-45 oil as a function of the degree of tBA hydrolysis (tBA total content 1.5 mol %);

FIG. 4 shows solution atomic force microscopy (AFM) images obtained in dioctyl ether of 1-2F1 nanospheres adsorbed on stainless steel surfaces before (left) and after (right) tBA group hydrolysis;

FIG. 5 is a schematic drawing (not to scale) of a preferred embodiment of the invention which is a substantially spherical nanometer-sized particle that is oil-soluble and contains metal-binding groups (“hooks”) on its surface;

FIG. 6 is schematic drawing of a general scheme for formation of a micelle followed by a core crosslinking step to produced a crosslinked nanosphere;

FIG. 7 illustrates a comparison between Stribeck-like curves of P(EXA-tBA)-PHEA (□), P(EXA-tBA)-PCEA (◯), and EHC-45 oil ();

FIG. 8 illustrates a comparison between Stribeck-like curves of P(EXA-tBA)-PHEA (□) and P(EXA-tBA)-PAOEA ();

FIG. 9 illustrates a comparison between Stribeck-like curves of P(EXA-tBA-AA)-PCEA Sample 1 () and P(EXA-tBA)-PCEA samples 1 (◯) and 2 (▴); and

FIG. 10 illustrates a comparison of SEC traces of Sample-CEA 1 and recovered Sample-CEA 1 micelles after different treatment.

### DETAILED DESCRIPTION OF THE PREFERRED EMBODIMENTS

This application reports the preparation of oil-dispersible polymer nanoparticles bearing metal-binding surface functional groups. For the purposes of this disclosure, the terms “hydrocarbon soluble,” “oil soluble,” and “oil or hydrocarbon dispersible” are not intended to indicate that the compounds are soluble, dissolvable, miscible, or capable of being suspended in a hydrocarbon compound or oil in all proportions. These do mean, however, that they are, for instance, soluble or stably dispersible in oil to an extent sufficient to exert their intended effect in the environment in which the oil is employed. Moreover, the additional incorporation of other additives may also permit incorporation of higher levels of a particular additive, if desired.

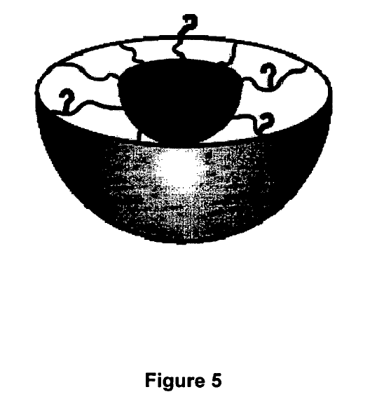

FIG. 5 is a schematic drawing (not to scale) of a preferred embodiment of the invention which is a substantially spherical nanometer-sized particle that is oil-soluble and contains metal-binding groups (“hooks”) on its surface. The average hydrodynamic diameter of the nanoparticle ranges from about 20 to about 250 nm, preferably about 20 to about 100 nm. (As a general rule of thumb, if the surface being lubricated is rough, a bigger sphere is preferred.) The core of the nanoparticle is substantially insoluble in oil over the utilization temperature of the oil. For the wide utilization temperature of lubricating oils, in some embodiments crosslinking of the core is preferred. The diameter of the core ranges from about 10 to about 150 nm, and is preferably between about 10 to about 80 nm. The shell, or corona, of the nanoparticle is oil soluble, particularly soluble in lubricating oils. Accordingly, nonpolar polymers are employed, which include but are not limited to poly(alkyl acrylate), poly(alkyl methacrylate), poly(alkylstyrene), poly(dimethylsiloxane), polyisoprene, polybutadiene, and polyisobutylene. In the corona or shell there are a number of polar groups that are metal binding. These include but are not limited to carboxyl groups, amino groups, pyridyl groups, carbonyl groups, hydroxyl groups, triazole groups and sulfate groups.

The nanospheres are made from block copolymers. Block copolymers are made by chemically joining different polymers in a head-to-tail fashion. The simplest block copolymer is a diblock copolymer AₙBₘ, which is polymer A with n repeat units joined in a head-to-tail fashion with polymer B with m repeat units. The simplest triblock copolymer is AₙBₘAₙ, which is two polymer A blocks with n units joined head-to-tail to a central polymer B block with m repeat units.

To introduce the metal-binding groups, we prepare diblocks AₙBₘ and triblocks AₙBₘAₙ with “impure” nonpolar A blocks, these becoming the coronal blocks of the nanospheres later. The “impure” A blocks are random copolymers of A and C. The total number of A and C units is still n. The molar fraction y of C in the AC block is preferably very low, ranging from 0 to 30% and preferably between 0.1 and 5%. An A and C random copolymer block is written as (A_{100%-y}C_{y})ₙ. C can be metal-binding groups that would bind directly to metals without any further chemical transformation. Alternatively, C can be “latent” metal-binding units, which will become metal-binding after some chemical transformation.

There are a number of approaches that can be used to introduce latent functional groups and then to convert them to stainless steel binding groups. These include:
One can copolymerize trimethylsilyl (meth)acrylate and then remove trimethylsilyl groups from the copolymerized units to generate (meth)acrylic acid.
One can copolymerize solketal (meth)acrylate and then remove acetone from the polymerized units to generate glyceryl (meth)acrylate which contain two hydroxyl groups.
One can copolymerize styrene and then sulfonate copolymerized styrene to produce sulfonated styrene.
The glyceryl (meth)acrylate units discussed above can react with succinic anhydride to yield carboxyl groups.
A copolymerized 4-[2-N,N-bis(trimethylsilyl)aminoethyl] styrene unit can be hydrolyzed to produce a 4-(2-aminoethyl) styrene unit.
Hydroxyl groups can be reacted with benzotriazole-5-carboxylic acid to introduce triazole groups.
Polybutadiene or polyisoprene residual double bonds can react with succinic anhydride to introduce carboxyl groups.
Click chemistry can be used to produce triazole groups and improve adhesion of polymer to copper (JOURNAL OF POLYMER SCIENCE PART A-POLYMER CHEMISTRY 42 (17): 4392-4403 Sep. 1, 2004).
A good reference on polymer functional group protection and removal is by S. Nakahama and A. Hirao Prog. Polym. Sci. 1990, 15, 299-335.

The following functional monomers may be introduced directly into a copolymer block: vinyl alcohol; vinyl pyridine, N-isopropylacrylamide, N,N-dialkyl-4-vinyllbenzamide, 2-hydroxyethyl (meth)acrylate and 2-(dimethylaminoethyl)ethyl methacrylate. It is possible to polymerize a small amount of acrylic acid, methacrylic acid, 4-styrenesulfonic acid, and vinylbenzoic acid with another oil-soluble copolymer directly.

Triazole and imidazole, for example, can be introduced into polymers via direct polymerization of monomers containing such functional groups. See, for example 1) “Copolymerization of 1-vinyl-1,2,4-triazole with 2-hydroxyethyl methacrylate” Ermakova T G, Kuznetsova N P, Maksimov K A RUSSIAN JOURNAL OF APPLIED CHEMISTRY 76 (12): 1971-1973 December 2003. 2) “Polymerization of N-allenylazoles” Morozova L V, Tatarinova I V, Markova M V, Mikhaleva A I, Tarasova O A, Trofimov B A POLYMER SCIENCE SERIES B 45 (11-12): 375-378 November-December 2003. 3) “Synthesis and rheological behavior of cross-linkable poly[N-(methaeryl-2-ethyl)-N-(3-amino(1,2,4-triazole-2-yl))urea-co-methyl methacrylate]” Glockner P, Osterhold M, Ritter H MACROMOLECULES 35 (6): 2050-2054 Mar. 12, 2002.

Another way to introduce the metal binding groups is to perform a chemical reaction on a “pure” A block in a controlled fashion so that only a small fraction of the A groups is transformed into metal-binding C groups.

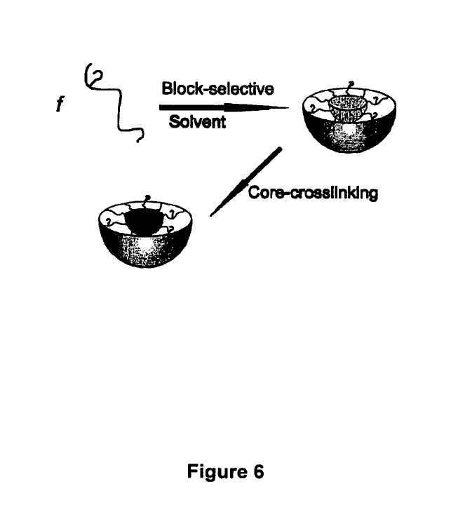

After block copolymer synthesis, the preparation of crosslinked nanospheres, a preferred embodiment, still requires at least two steps according to the scheme depicted in FIG. 6. The first step involves micelle formation. Here, one selects and uses a solvent that is good for the “hook-containing” corona block and poor for the core block. This causes the polymer of the “hook-containing” corona block to dissolve, whereas the core block segregates out from the solvent phase. A compromise between these two opposing effects yields micelles from the copolymer in the block-selective solvent. The core size of the micelles cannot be larger than the length of the core block. One can select the diameter of the core by changing the molar mass (length) of the core block, e.g., between about 10 and about 150 nm, preferably about 10 to about 80 nm. It should be understood that in such a block-selective solvent, the insoluble block may form the core of either spherical or cylindrical aggregates, depending on the m/n value of the diblock and the solvent.

The second step involves the “locking in” of the micellar structure permanently. This is the core crosslinking step. Core crosslinking can be achieved photochemically, thermally, or chemically, depending on the chemical composition of the core block. Core crosslinking may even possibly occur spontaneously during micelle storage at room temperature or usage as a friction modifier at high temperature.

If only “latent hooks” are incorporated into the precursor diblock copolymer, a third step will be needed that transforms the “latent hooks” to functional metal-binding groups.

Nanospheres can be prepared from (A_{100%-y}C_{y})ₙBₘ(A_{100%-y}C_{y})ₙ triblocks similarly as from (A_{100%-y}C_{y})ₙBₘ diblocks.

The particles can be made also from triblock copolymers CₗAₙBₘ, where C is again the metal-binding monomer. The l number here is an integer and can range between 0 and about 50, preferably between 0 and about 5. l=1 is especially preferred. CₗAₙBₘ differs from (A_{100%-y}C_{y})ₙBₘ in that the metal-binding monomer units are clustered together in the former to form a C block and the C monomers are randomly distributed inside an A block in the latter.

When l=0, we have a diblock copolymer. As long as A has some attraction to metal, nanoparticles made from a pure AₙBₘ diblock may also work as friction modifier.

The particles can also be made from penta-block copolymers CₗAₙBₘAₙCₗ, where C is the metal-binding group. The l number can range between 0 and about 50, preferably between 0 and 5. l=1 is especially preferred.

For nanosphere preparation from (A_{100%-y}C_{y})ₙBₘ diblocks or (A_{100%-y}C_{y})ₙBₘ(A_{100%-y}C_{y})ₙ triblocks, it should be noted that y can be 0%. If y=0%, we have pure di- and tri-block copolymers.

Oil-dispersible nanologs or nanocylinders according to the invention can be obtained by increasing m/n, as is known for other block copolymers.

A diblock copolymer micellization approach to produce oil dispersible nanospheres is described in detail below. Unlike fullerenes or inorganic nanoparticles, the diblock copolymer micelle approach enables better particle size, shape, and surface functional group control. The resulting polymer nanoparticles can be made to disperse well in oil. These aspects increase the benefits of the nanoparticles; for example, they are useful as an additive to oil for lubrication, anti-friction and anti-wear applications.

In certain embodiments of the invention, polymer nanoparticles are essentially colorless and are visually more appealing when added to oil. This is in contrast to inorganic particles, buckyballs and metal particles often being quite dark.

In preferred embodiments of the invention, oil-dispersible polymer nanospheres contain tunable amounts of carboxyl groups. The carboxyl groups help the adsorption of the spheres onto stainless steel surfaces. The core size of the spheres can be tuned from about 10 nm to about 80 nm.

Referring to a preferred embodiment, nanoparticles were prepared from poly[(2-ethylhexyl acrylate)-ran-(tert-butyl acrylate)]-block-poly(2-cinnamoyloxyethyl acrylate) or P(EXA-tBA)-PCEA:

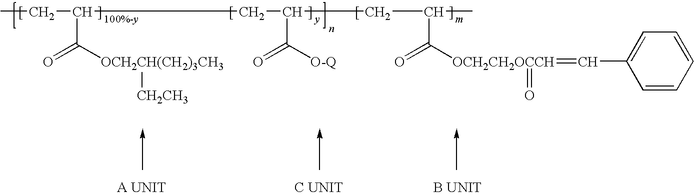

where Q is tert-butyl or tetrahydropyranyl, y ranges from 0 to about 5%, m ranges from about 10 to about 10,000 (preferably from about 10 to about 500) and n ranges from about 10 to about 10,000 (preferably from about 10 to about 500).

Here, ran or r means random, and block or b mean block. As used herein, these italicized descriptors are not always included in the composition name, but there is no intended implication about structural features. The P(EXA-r-tBA) block was chosen to provide the corona of the particles for its ready solubility in lubricating base oils, which consist mostly of paraffins, aromatics and naphthenes (cycloparaffins). A small mole fraction y of tBA, e.g. less than 0.5 mol %, was incorporated into the P(EXA-tBA) block so that we could selectively hydrolyze tBA to acrylic acid (AA) groups to facilitate nanoparticle adsorption on the surfaces of metals or other substrates. The PCEA block was chosen for its photocrosslinkability, which allowed us to lock in the structure of micelles formed from the diblock copolymer in block-selective solvents. The glass transition temperature of the derivatized PHEA block may be adjusted by reacting a fraction of the HEA hydroxyl groups with octanoyl chloride to yield poly((2-cinnamoyloxyethyl acrylate)-ran-(2-octanoyloxyethyl acrylate)) or P(CEA-r-OEA).

As described in detail below, the micelles were prepared from a one-step method involving dispersing a diblock directly in hot cyclohexane or a hot engine oil. Alternatively, they can be prepared from a two-step method involving dissolving a diblock in THF first and then adding cyclohexane or engine oil. THF can be removed from engine oil under rota-evaporation. The micelles consisted of the insoluble PCEA cores and soluble P(EXA-tBA) coronas. Nanospheres were obtained after we locked in the structure of the spherical micelles by photolyzing them with UV light to crosslink PCEA.

Accordingly, in this preferred embodiment, the preparation of the nanospheres involves the following steps: 1) P(EXA-tBA)-PCEA synthesis, 2) micelle formation from P(EXA-tBA)-PCEA in cyclohexane or THF/cyclohexane, 3) optionally, crosslinking of PCEA core by photolysis, and 4) hydrolysis or partial hydrolysis to produce carboxyl groups on the surface of the spheres to increase the binding between the spheres and metal surfaces. The micelles may undergo self crosslinking or crosslinking spontaneously during storage or use. In this case, sample preparation involved 1) P(EXA-tBA)-PCEA synthesis, 2) Hydrolysis or partial hydrolysis of tBA to acrylic acid (AA), and 3) micelle formation of P(EXA-AA)-PCEA in hot engine oil.

While not desiring to be bound by theory, it is believed that lubricating oils achieve lubrication primarily by two mechanisms. Based on the law of fluid dynamics, a hydrodynamic pressure pushing two sliding surfaces apart is the highest in regions where the two surfaces are the closest. The pressure supports the load and avoids the direct contact of the sliding surfaces in the hydrodynamic lubrication (HDL) regime. In a high load and/or low speed situation, a lubricant system enters a mixed lubrication (ML) or a boundary lubrication (BL) regime and the asperities of the surfaces are inevitably in partial or extensive contact. A lubricant containing amphiphilic molecules avoids the direct contact of the asperities by forming a film on the surfaces. Accordingly, the invention provides methods of reducing friction comprising providing an oil-dispersible nanoparticle as described herein as an additive to an oil employed for lubrication. The invention further provides methods of reducing wear of machine parts comprising providing an oil-dispersible nanoparticle as described herein as an additive of an oil contacting said machine parts.

Embodiments of the present invention will be described with reference to the following examples which should not be used to construe or limit the invention.

### EXAMPLES

Materials and Reagents. N,N,N′,N″,N″-pentamethyl-diethylenetriamine (PMDETA, 99%), 2-ethylhexyl acrylate (EXA, 98%), tert-butyl acrylate (tBA, 99.5%), methyl 2-bromopropionate (MBP, 98%), diisopropylamine (98%), 1-bromohexane, and pyridine (99+%) were purchased from Aldrich. EXA was washed by 5% NaOH aqueous solution thrice to remove stabilizer and then dried over anhydrous MgSO₄ overnight. It was distilled under vacuum over CaH₂ prior to use. Monomer tBA was distilled over CaH₂. PMDETA and diisopropylamine were distilled prior to use. MBP and 1-bromohexane were distilled under vacuum. P yridine was dried by refluxing with calcium hydride and distilled prior to use. Monomer 2-trimethysiloxyethyl acrylate (HEA-TMS) was synthesized following a literature method—see: (a) Muhlebach, A.; Gaynor, S. G.; Matyjaszewski, K. Macromolecules, 1998, 31, 6046, and (b) Qiu, X. P.; Liu, G. J. Polymer, 2004, 45, 7203 Cinnamoyl chloride (98%), 4,4′-dimethyl-2,2′-bipyridine (dMbipy), n-butyllithium (2.5 M in hexanes), CuBr (99.999%), CuBr₂ (99.999%) were purchased from Aldrich and used as received.

Techniques. NMR was performed with Bruker Avance-300 or Bruker Avance-500 using CDCl₃ as solvent. Size exclusion chromatography was performed using THF as eluant. The Waters μ-Syragel® HT-4 and 500 Å columns used were calibrated by polystyrene standards. UV absorbance was determined using a Perkin-Elmer Lambda 2 instrument. Dynamic Light Scattering (DLS) data were obtained with a Brookhaven model 9025 instrument using a He—Ne laser operated at 632.8 nm. The scattering angle used was 90°. Transmission Electron Microscopy (TEM) was performed on Hitachi-7000. TEM sample was obtained by aspirating a fine mist of a diluted solution of the nanospheres onto a carbon-coated copper grid using a home-built device. The samples were stained by OsO₄ for about 1 h before observation.

Lubrication Tests. The lubrication tests were performed on a mini-traction machine (also known as an MTM). In such a machine, a lubricated contact is formed between a steel ball with a diameter of 19 mm and a disk with a diameter of 46 mm by immersing the disk fully in a diblock oil solution. The surface roughness of the ball and disk is ˜20 nm. The ball and disk were driven by separate DC motors so that their tangential speeds U_{b} and U_{d} at the point of contact can be changed independently to yield a fixed slide to rolling ratio |U_{b}−U_{d}|/U of 20%, where U is the oil entrainment speed or mean rolling speed of the moving parts.

Synthesis of 4,4′-diheptyl-2,2′-bipyridine (dHbipy). This ligand used for EXA and tBA copolymerization was synthesized following a literature method—see Matyjaszewski, K.; Patten, T. E.; Xia, J. H. J. Am. Chem. Soc., 1997, 119,674. To a 500-mL three-neck round-bottom flask purged by argon were added 7.36 mL (5.27 g, 52.1 mmol) of diisopropylamine and 50.0 mL of dry THF. The solution was cooled to −78° C. before 19.8 mL (2.5 M in hexane, 49.6 mmol) of butyllithium were added dropwise under stirring. After 15 min, the solution was warmed to 0° C. and allowed to stir for 30 min. The solution was cooled to −78° C. again. A solution of 4.0 g (21.7 mmol) of 4,4′-dimethyl-2,2′-bipyridine and 110 mL of dry THF was added slowly. The mixture was stirred for 3 h and the temperature was kept below −45° C. The mixture was warmed to 0° C. and stirred for 0.5 h. The mixture was then cooled down to −78° C. again before 9.19 mL (10.8 g, 65.5 mmol) of 1-bromohexane were added dropwise. The final mixture was warmed to room temperature overnight and was then poured into water. The aqueous phase was extracted with ethyl acetate (3×100 mL). The organic phase was combined and dried over Na₂SO₄, filtered, and concentrated by rota-evaporation. The product was purified by activated neutral aluminum oxide chromatography. Further purification was achieved by recrystallization in ethanol to afford 2.85 g of dHbipy.

Preparation of P(EXA-tBA). To an argon-purged 250-mL round-bottom flask were added 110.6 mg (0.77 mmol) of CuBr and 9.2 mg (0.04 mmol) of CuBr₂. The flask was evacuated and refilled by Ar and this procedure was repeated twice before 5.0 mL of toluene, 30.0 mL (26.5 g, 143.9 mmol) of EXA, and 0.32 mL (0.28 g, 2.20 mmol) of tBA were added. Also added were 858.9 mg (2.44 mmol) of dHbipy dissolved in 10.0 mL of Ar-purged toluene and 90.6 μL (135.6 mg, 0.81 mmol) of MBP (methyl 2-bromopropionate). The mixture was cooled down to −78° C., evacuated, thawed, and refilled with Ar. The procedure was repeated twice before the flask was immersed in an oil bath preheated at 85° C. The polymerization was performed at this temperature for 4.5 days. After cooling to room temperature, the mixture was diluted with THF and filtered through a column of aluminum oxide to remove the catalyst. The filtrate was concentrated by rota-evaporation to 200 mL.

To fractionate the polymer, 160 mL of methanol were added dropwise to the filtrate so that the solution just turned cloudy. The resultant solution was left standing overnight at room temperature to yield two phases. The denser bottom layer was collected and later discarded. To the top layer were added another 5.0 mL of methanol before it was left standing overnight at 2° C. The bottom dense layer was collected and added into methanol to precipitate out the polymer. The collected precipitate was dried in a vacuum oven at 40° C. for 10 h to yield 17.6 g of polymer.

Preparation of P(EXA-tBA)-P(HEA-TMS). An example preparation involved first adding into a 100-mL round-bottom flask 6.74 g or 0.27 mmol of P(EXA-tBA), 6.0 mL of 2-butanone, 34.4 mg (0.24 mmol) of CuBr, 5.9 mg (0.03 mmol) of CuBr₂, 9.48 mL (9.0 g, 47.9 mmol) of HEA-TMS, and 55.5 μL (46.1 mg, 0.27 mmol) of PMDETA. The mixture was cooled down to −78° C., evacuated, thawed, and refilled with Ar. The procedure was repeated twice. The flask was immersed in an oil bath preheated at 60° C. The polymerization was performed at this temperature for 28 h. After cooling to room temperature, the mixture was diluted with THF and filtered through a column of aluminum oxide to remove the catalyst. The filtrate was concentrated by rota-evaporation to 250 mL. To fractionate the polymer, 30 mL of distilled H₂O were added dropwise under stirring. The resultant solution was then left standing overnight at 2° C. The denser bottom layer was collected as the product with a sample code of 1-1F1(TMS) and a yield of 7.9 g.

Preparation of P(EXA-tBA)-PHEA. Into a round-bottom flask with a magnetic stir bar were added 3.97 g of 1-1F1(TMS) and 50 mL of THF. After 1-1F1(TMS) dissolution, 2.0 mL of distilled H₂O and 1.0 mL of acetic acid were added. The mixture was stirred at room temperature for 12 h and then purified by dialysis against THF in a tube with a molar mass cut-off of 12000-14000 g/mol. THF was removed from the final solution by rota-evaporation to yield solid P(EXA-tBA)-PHEA.

Synthesis of P(EXA-tBA)-PCEA. Into a 100 mL round-bottom flask were added 3.06 g of the above P(EXA-tBA)-PHEA sample. Also added were 60.0 mL of dry pyridine and 2.25 g (13.5 mmol) of cinnamoyl chloride. The mixture was stirred at room temperature for 12 h. It was then centrifuged and filtered to remove the pyridium chloride salt. The supernatant was added into methanol to precipitate the polymer, which was further purified by redissolving it in THF and re-precipitating it into methanol. The final precipitate was dried in a vacuum oven at room temperature for 12 h to yield 3.51 g of product 1-1F1.

Characterization of P(EXA-tBA)-PCEA. Table 1 shows the characteristics of two P(EXA-tBA)-PCEA samples that we prepared. The samples from different batches are called 1-1F1 and 1-2F1 for convenience. The former is described in detail below.

TABLE 1
Characteristics of P(EXA-tBA)-PCEA samples.

| | SEC | | | | | | | |
|---|---|---|---|---|---|---|---|---|
| | 10⁻⁴ × M_{w} | SEC | dnᵣ/dc | LS | NMR | | | Amount |
| Code | (g/mol) | M_{w}/Mₙ | (mL/g) | M_{w} | n/m | n | m | (g) |
| 1-1F1 | 5.6 | 1.24 | 0.125 | 6.3 × 10⁴ | 1.00/0.65 | 147 | 96 | 2.8 |
| 1-2F1 | 5.0 | 1.24 | 0.114 | 7.6 × 10⁴ | 1.00/0.58 | 187 | 109 | 4.2 |

SEC denotes size exclusion chromatography.
M_{w} denotes weight-average molar mass.
M_{w}/Mₙ denotes sample polydispersity index, where Mₙ is the number-average molar mass.
dnᵣ/dc is the specific refractive index increment.
LS is an abbreviation for light scattering.
The number n is the total number of EXA and tBA units in the polymer.
The number m is the number of CEA units in the polymer.

P(EXA-tBA)-PCEA Micelles in THF/cyclohexane or Cyclohexane. Two methods were used to prepare the micelles. Method 1 is simpler and more direct. It involved dispersing P(EXA-tBA)-PCEA in hot cyclohexane (CH) directly, which solubilizes P(EXA-TBA) and not PCEA. Method 2 involved two steps, dissolving the diblocks in THF first and then adding CH slowly. In an example preparation, we started by dissolving 2.65 g of 1-1F1 in 26.5 mL of THF. Then, added dropwise from a dropping funnel, were 105.9 mL of CH under magnetic stirring. The solution was kept stirring at room temperature for 11 h before irradiation at 20° C. with UV light from a 500-W mercury lamp that had passed a 270-nm cut-off filter. The degree of CEA conversion was determined from CEA absorption intensity decrease at 274 nm and was controlled to be ˜35%.

Table 2 shows how the hydrodynamic diameter of the micelles varied with cyclohexane content. The size of the micelles determined from dynamic light scattering (DLS) was essentially independent of the cyclohexane volume fraction f_{CH} at room temperature until it reached ˜99%.

TABLE 2
Variation in the DLS hydrodynamic diameters dₕ of
P(EXA-tBA)-PCEA micelles prepared at room temperature
as a function of f_{CH}. The data were obtained at the
scattering angle of 90°.

| | | |
|---|---|---|
| | | Polydispersity |
| f_{CH} | dₕ (nm) | K₂²/K₄ |

Micelles of 1-1F1

| | | |
|---|---|---|
| 80% | 50 | 0.041 |
| 90% | 45 | 0.075 |
| 95% | 46 | 0.062 |
| 98% | 46 | 0.076 |
| 99.5% | 79 | 0.085 |
| 100% | 89 | 0.093 |

Micelles of 1-2F1

| | | |
|---|---|---|
| 80% | 46 | 0.017 |
| 99% | 50 | 0.095 |
| 100% | 97 | 0.100 |

We also checked how temperature increase affected the size of the micelles of 1-2F1 formed in cyclohexane (Table 3).

TABLE 3
Variation of cyclohexane equilibration temperature on
the properties of 1-2F1 micelles.

| | | Polydispersity |
|---|---|---|
| T (° C.) | dₕ (nm) | K₂²/K₄ |
| 22 | 97 | 0.100 |
| 55 | 88 | 0.081 |
| 81 | 85 | 0.084 |

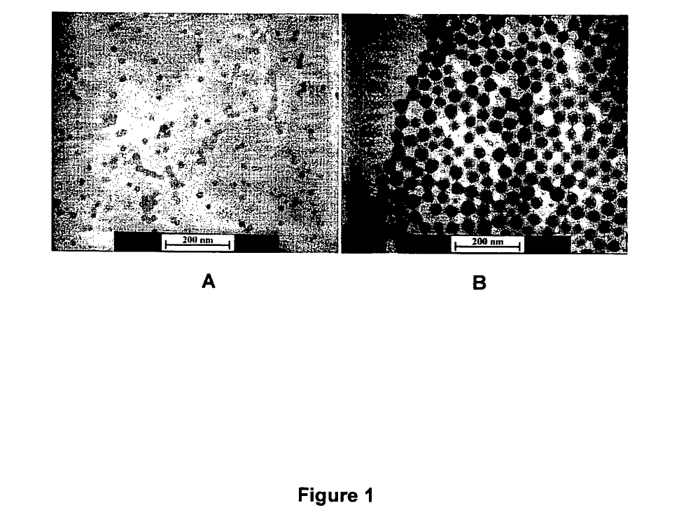

P(EXA-tBA)-PCEA Spheres. P(EXA-tBA)-PCEA micelles in THF or THF/CH were photolyzed to achieve a CEA double bond conversion of ˜35% to yield nanospheres. Table 4 summarizes the properties of nanospheres samples that we prepared. FIG. 1 shows the transmission electron microscopy (TEM) images of the spheres. The core diameter is ˜20 nm for the 1-1F1 nanospheres and ˜40 nm for the 1-2F1 spheres.

TABLE 4
Preparation conditions and characteristics of nanospheres.

| | | | | Polydispersity | Amount |
|---|---|---|---|---|---|
| Polymer | Solvent | T (° C.) | dₕ (nm) | K₂²/K₄ | (g) |
| 1-1F1 | f_{CH} = 80% | 20 | 45 | 0.033 | 1.7 |
| 1-2F1 | f_{CH} = 100% | 55 | ~88 | | 3.0 |

P(EXA-tBA-AA)-PCEA Spheres. Carboxyl groups could be obtained from the hydrolysis of tBA to acrylic acid (AA) units. Spheres with only a fraction of the tBA hydrolysed are P(EXA-tBA-AA)-PCEA spheres. More specifically, the tBA units of the nanospheres were hydrolyzed in methylene chloride and trifluoroacetic acid at v/v=95/5. We controlled the degree of tBA hydrolysis by varying the hydrolysis time. To establish the hydrolysis kinetics, we used samples that were 30.0 mg in size. The typical procedure involved dispersing 30.0 mg of nanospheres in 6.0 mL of CH₂Cl₂ first. To it were then added 0.51 μL of triethylsilane and 0.33 mL of trifluoroacetic acid. The mixture was stirred for a pre-designated time before 1.5 mL of methanol were added to terminate the hydrolysis reaction. The mixture was then immediately concentrated and added into methanol to precipitate the nanospheres. The nanospheres were washed by methanol 3 times, and then dried in a vacuum oven at room temperature for 20 h for NMR analysis.

The EXA and tBA groups are nonpolar, which make the nanospheres dispersible in lubricating oils. These spheres do not stick to stainless steel surfaces very well and they will not form a dense layer on metal surfaces. Carboxyl groups interact with metal well and will help increase adhesion of the spheres to metals. However, too many carboxyl groups will decrease the degree of dispersion of the spheres in lubricating oil. Thus, we optimized the AA molar amounts in the nanospheres. Nanospheres with different amounts of AA groups were obtained in the current systems by hydrolyzing tBA to different extents.

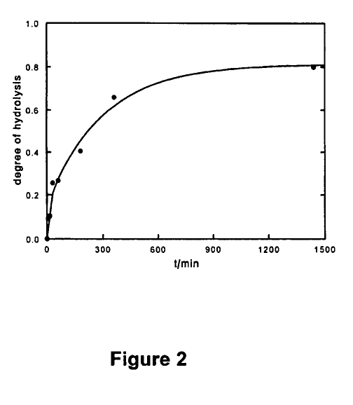

FIG. 2 shows that we can indeed control the degree of tBA hydrolysis by changing the hydrolysis time. The solid line represents the best fit to the experimental data by a sum of two exponential terms:

y_{H}=0.8135−0.1491×e^{-(t/11.65)}−0.6621×e^{-(t/295.2)} (1)

We use equation (1) to calculate the degree of tBA hydrolysis in the 1-1F1 and 1-2F1 spheres. If we hydrolyzed tBA for 30 min, equation (1) gives a degree of hydrolysis of 20.4%. Since the molar fraction of AA groups in the corona (shell) of the spheres is only 1.5%, the molar fraction of the AA groups in the corona is 0.31%.

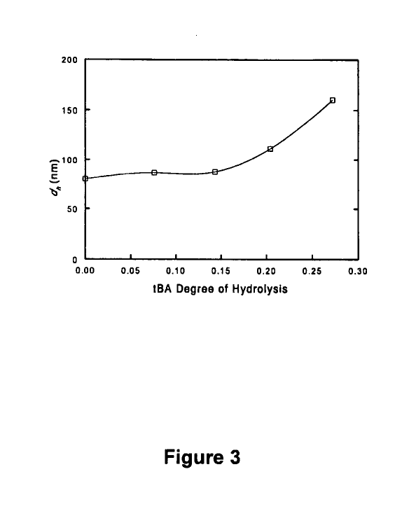

Too many AA groups in the corona of the spheres will lead to the precipitation of the spheres from oil. Before that happens, the spheres will form smaller clusters. The size of these clusters can be determined by dynamic light scattering. Plotted in FIG. 3 is the variation in the hydrodynamic diameters dₕ of the 1-1F1 spheres in EHC-45 (ExxonMobil) oil (obtained from Afton Chemical, Richmond, Va.) as a function of the degree of tBA hydrolysis. The data indicate that the particles did not aggregate below the tBA degree of hydrolysis of ˜15%, because dₕ increased only above this degree of hydrolysis.

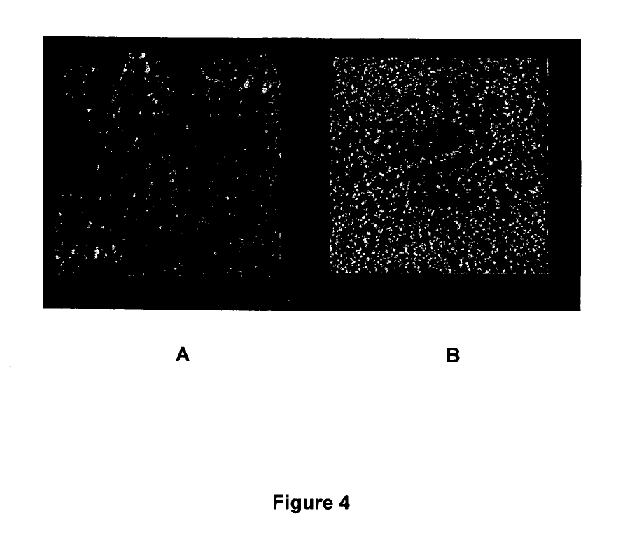

Adsorption of Nanospheres on Steel Surfaces. We showed by atomic force microscopy (AFM) that nanospheres with AA groups adhere to stainless steel surfaces well and the spheres without carboxyl groups adsorbed only slightly. This involved imaging nanospheres adsorbed on stainless steel surfaces (308 Stainless Steel, #8 Finish, McMaster-Carr, Chicago) under a layer of dioctyl ether solvent. FIG. 4 compares solution-phase atomic force microscopy (AFM) images obtained for 1-2F1 spheres before and after the hydrolysis of ˜27% of the tBA groups (0.41 mol % of AA groups). The density of the adsorbed number of spheres had definitely increased in the latter case, indicating the effectiveness of the AA groups in enhancing nanosphere adsorption.

Preparation of P(EXA-tBA)-PHEA. This preparation involved first adding into a 100-mL round-bottom flask 6.71 g of P(EXA-tBA), 2.0 mL of 2-butanone, 22.2 mg (0.155 mmol) of CuBr, 1.8 mg (0.008 mmol) of CuBr₂, 9.68 mL (9.21 g, 48.9 mmol) of HEA-TMS, and 34.0 μL (28.2 mg, 0.163 mmol) of PMDETA. The mixture was cooled down to −78° C., evacuated, thawed, and refilled with Ar. The procedure was repeated twice. The flask was immersed in an oil bath preheated at 60° C. The polymerization was performed at this temperature for 26 h. After cooling to room temperature, the mixture was diluted with THF and filtered through a column of aluminum oxide to remove the catalyst. The filtrate was concentrated by rota-evaporation and the polymer was precipitated by adding into a mixture of water and methanol (1/3, v/v). The obtained polymer was dried at room temperature for 16 h to yield 11.1 g of a highly viscous gum.

To hydrolyze the TMS groups, 9.90 g of the P(EXA-tBA)-P(HEA-TMS) sample was added into a round-bottom flask with a magnetic stir bar and dissolved in 205 mL of THF. To the mixture were then added 12.8 mL of distilled water and 12.8 mL of acetic acid. The mixture was stirred at room temperature for 12 h before purification by dialysis against THF in a tube with a molar mass cut-off of 12000-14000 g/mol. THF was removed from the final mixture by rota-evaporation.

Preparation of P(EXA-tBA)-PAOEA. P(EXA-tBA)-PHEA, 0.91 g containing 2.61 mmol of HEA units was added into a 100-mL round-bottom flask. After flushing the system with nitrogen and sealing with a rubber septum, 20 mL of dry pyridine was added via a syringe to dissolve the diblock. This was followed by the slow addition of 2.46 mL (2.66 g or 26.1 mmol) of acetic anhydride. The mixture was stirred at room temperature for 18 h before it was added into 400 mL of methanol to precipitate out the polymer. The obtained polymer was dried in vacuum oven at room temperature for 12 h with a yield of 0.81 g. The quantitative reaction between the HEA groups and acetic anhydride was confirmed by a ¹H NMR analysis. Since the conditions used to perform this reaction were mild, it is believed that the reaction did not lead to any polymer degradation or crosslinking. This was validated by an insignificant change in both the peak shape and position of P(EXA-tBA)-PAOEA and P(EXA-tBA)-PCEA.

P(EXA-tBA)-PHEA, P(EXA-tBA)-PCEA, P(EXA-tBA-AA)-PCEA and P(EXA-tBA)-PAOEA Micelles in EHC-45 Oil. In this example all the polymers were derived from one parent diblock copolymer P(EXA-tBA)-PHEA with n=380, m=270, and y=0.5%. The P(EXA-tBA)-PCEA sample was obtained from reacting the P(EXA-tBA)-PHEA diblock with cinnamoyl chloride and will be denoted as Sample-CEA 1 hereinafter. Sample P(EXA-AA)-PCEA or Sample-AA 1 was derived from hydrolyzing 20% of the tBA groups of Sample-CEA 1. PAOEA denotes poly(2-acetoxyethyl acrylate) and was obtained from reacting PHEA with acetic anhydride. Micelle were prepared from these four diblocks in EHC-45 engine base oil by dissolving a polymer in THF first. To the solution was then added EHC-45 oil. THF was finally removed by rota-evaporation. In every case the final concentration of the diblock in the base oil was 5.0 mg/mL or approximately 0.5 wt %. In an example preparation, 0.60 g of a Sample-CEA 1 with was dissolved in 6.0 mL of THF, then 120 mL of EHC-45 oil was added slowly under stirring. The mixture was rota-evaporated for 2 h to remove THF. The micellar solution was stirred at least for another 12 h before any physical studies or testing.

Crosslinked P(EXA-tBA)-PHEA Micelles. To crosslink micelles of P(EXA-tBA)-PHEA, 6.0 mL of such a sample in EHC-45 containing 30.0 mg of the diblock and 0.086 mmol of HEA units were degassed by N₂ bubbling before being heated to 100° C. and the addition of 15.3 μL (15.0 mg or 0.189 mmol) of pyridine and 9.69 μL (13.3 mg or 0.086 mmol) of succinyl chloride by micro syringes. The mixture was left at 100° C. for 3 h before being cooled to room temperature. For TEM examination of the crosslinked micelles, the crosslinked sample was dialyzed against THF to remove the base oil. The dialyzed sample in THF was sprayed on TEM grids for TEM observation without further staining.

Preparation of P(EXA-tBA-AA)-PCEA 1 or Sample-AA 1. The conditions used to hydrolyze Sample-CEA 1 were established before (Liu, G. J. Oil Dispersible Polymer Nanoparticles, 2005) based on a model P(EXA-tBA)-PCEA sample with 6 mol % of tBA in the P(EXA-tBA) block. The higher tBA content was used so that ¹H NMR spectroscopy could be used to follow the hydrolysis kinetics. The tBA content was still sufficiently low so that the tBA environments in the model polymer are similar as those in the current polymer. Based on kinetic results of the model system, the hydrolysis conditions used should produce P(EXA-tBA-AA)-PCEA with 20% of the tBA groups hydrolyzed. Thus, the total AA content in the P(EXA-tBA-AA) block was 0.1 mol % in Sample-AA 1. Such a low AA content was sought as we determined that higher AA contents led to significant inter-micellar association and eventually polymer precipitation.

Appearance of the Diblock Micelles. EHC-45 oil is a good solvent for P(EXA-tBA) but acts as a precipitant for PCEA, PAOEA, and PHEA. In such a solvent, P(EXA-tBA)-PHEA, P(EXA-tBA)-PCEA, P(EXA-tBA-AA)-PCEA and P(EXA-tBA)-PAOEA should form micelles with P(EXA-tBA) or P(EXA-tBA-AA) making up the corona and the PHEA, PCEA, or PAOEA block making up the core. Micellar solutions of P(EXA-tBA)-PCEA and P(EXA-tBA-AA)-PCEA all show strong turbidity, suggesting formation of micelles. On the other hand, solutions of P(EXA-tBA)-PHEA and P(EXA-tBA)-PAOEA are clear despite the fact that micelles should form from these two diblocks for the demonstrated insolubility of PHEA and PAOEA in EHC-45 oil.

While this difference in the appearance of the various micellar solutions could be caused by the differences in the size and morphology of the micelles, our TEM evidence suggests that micelles of all diblocks were spherical in shape and are similar in size. Thus, the P(EXA-tBA)-PAOEA and P(EXA-tBA)-PHEA micelles scattered the least amount of light because the refractive index difference between PHEA or PAOEA and EHC-45 is much smaller than that between PCEA and EHC-45. Our measurements have indicated that the refractive index of EHC-45 oil at the sodium line of 589.3 nm is 1.467 and the refractive index of PCEA should be ˜1.58 based on the dnᵣ/dc value of 0.0938 g/mL that we determined for PCEMA in toluene—see Tao, J.; Guo, A.; Liu, G. J. Macromolecules 1996, 29, 1618. Based on the known refractive indices of 1.5119 for poly(2-hydroxyl methacrylate), 1.471 for poly(2-ethoxyethyl acrylate), and 1.483 for poly(2-ethoxyethyl acrylate) (Brandrup, J.; Immergut, E. H., Polymer Handbook. 3rd ed.; John Wiley & Sons: New York, 1989), we estimated that the refractive indices of PHEA and PAOEA should be ˜1.50 and ˜1.47, respectively. Thus, the latter two polymers do have refractive indices closer to that of the base oil. The fact that one can change the visual appeal of a micellar solution in oil by fine-tuning the composition of a block copolymer may turn out to be useful in the future commercialization of such micellar products.

Self- or Auto-crosslinking of Sample-CEA 1 Micelles. Sample-CEA 1 micelles in either THF/cyclohexane (CH) with f_{CH}=90% or decahydronaphthalene (DN) were prepared and tested for the stability against storage and heating. To prepare micelles of the sample in THF/CH, 10.8 mg of Sample-CEA 1 was dissolved in 1.08 mL of THF. Then 9.72 mL of cyclohexane was added dropwise under stirring. To test the stability of the micelles against storage, we left such a sample in an unwrapped clear bottle on a lab bench for 21 days. After this, the micelle solution was concentrated and added into methanol to precipitate the polymer. After drying under vacuum, the solid product was dissolved in THF and analyzed by SEC.

To prepare micelles of the diblock in DN, 5.8 mg of the diblock was dissolved in 0.3 mL of THF. Then 5.8 mL of DN was added dropwise under stirring. THF was mostly removed by rota-evaporation at room temperature. The micellar solution was heated to 100° C. for 4 h. After cooling down, the micelle solution was dialyzed against THF to remove DN. The THF solution was concentrated and added into methanol to precipitate the polymer. The solid was dried under vacuum, re-dissolved in THF, and analyzed by SEC.

FIG. 10 below compares SEC traces of Sample-CEA 1 (labeled as “original”) and the recovered micellar samples discussed above. The trace labeled as “heated” was obtained for the recovered micellar sample that had been heated in DN at 100° C. for 4 h. The trace labeled as “stored” was for the recovered micellar sample in THF/CH after storage under ambient light and temperature for 21 days. The appearance of new peaks between the retention times of 18.6 and 20 min is indicative of formation of crosslinked micelles. The new shoulder next to the main peak at the higher-molar-mass or lower retention time side developed most probably due to dimerization and trimerization of P(EXA-tBA)-PCEA chains, which are intermediates between unimolecular P(EXA-tBA)-PCEA chains and crosslinked micelles.

Trends of Lubrication Results. All lubrication tests were done using a mini-traction machine at a slide to roll ratio that simulates real world contact conditions in automobiles. In every case the polymer concentration used was 5.0 mg/mL.

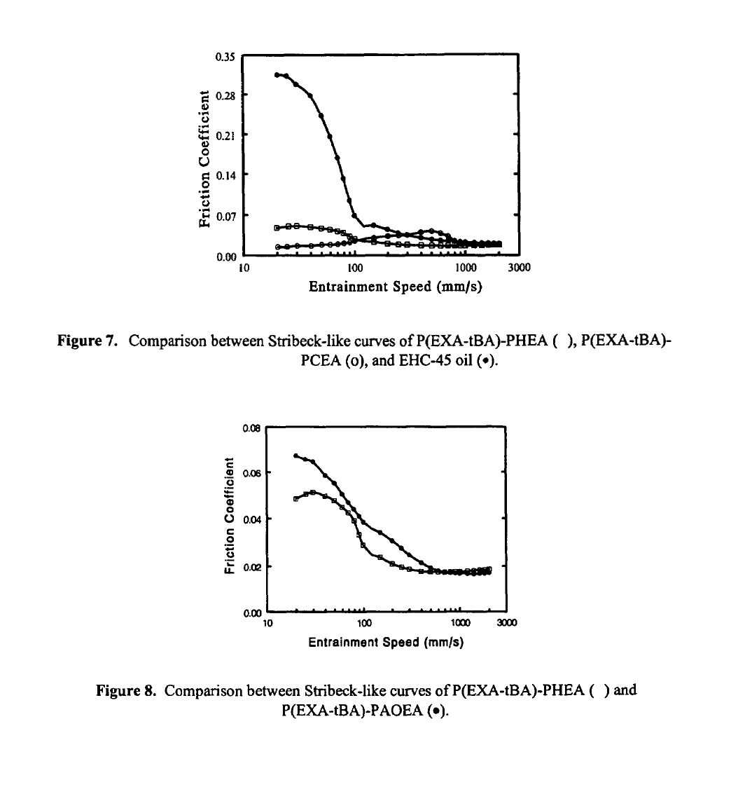

FIG. 7 shows some representative lubrication results, which were obtained for EHC-45 oil and for oil solutions of P(EXA-tBA)-PHEA and P(EXA-tBA)-PCEA micelles at 100° C., respectively. In such a graph known as a Stribeck-like curve, friction coefficients g are plotted as a function of entrainment speed U in the range of 20 to 2000 mm/s. In the case of EHC-45 μ increased initially slowly with decreasing U. The rate of μ increase picked up below U≈500 mm/s and eventually leveled off at the lowest U values.

Such curves are called Stribeck-like curves because μ is plotted as a function of ηU/W in a classical Stribeck curve (Hamrock, B. T.; Dowson, D., Ball Bearing Lubrication: The Elestohydrodynamics of Elliptical Contacts. John Wiley: New York, 1981) where η is the effective viscosity of an entrapped liquid film between two mating surfaces and W is the load applied on them. According to Spikes et al. (de Vicente, J.; Stokes, J. R.; Spikes, H. A. Food Hydrocolloids 2006, 20, 483), η is essentially a constant independently of U, which is contradictory to the shear-dependent viscosity behavior of a bulk liquid and is attributed to the confinement effect of a thin liquid film in a narrow gap. Thus, we have been able to plot μ vs. U to yield curves that are essentially identical in shape as the classical Stribeck curves.

As is known in the art, a classical Stribeck curve assumes a shape analogous to an acid-base tritration curve. At low U in the boundary lubrication (BL) regime, the load is fully supported by asperity contact of the surfaces and the friction coefficient μ is high. In this regime, μ typically changes very little with U. As U increases, the lubricating film thickness increases and the system enters the mixed lubrication regime where the load is supported by both asperity contact and hydrodynamic pressure generated by the lubricating liquid film. In this regime, t decreases fairly abruptly with U. Further increases in U bring the system into the elastohydrodynamic (ELH) regime where the load is fully supported by the fluid film and μ increases with U slowly.

A close inspection of the EHC-45 oil curve indicates that the system did not enter the ELH regime fully even at the highest U of ˜2000 mm/s for the lack of an μ increasing trend with U. The system entered the mixed lubrication regime fully only below U≈500 mm/s and entered the BL regime only at the lowest U values.

The P(EXA-tBA)-PHEA curve is similar in shape to that of the base oil but with the mixed and BL regimes better defined. A major difference between the base oil and this diblock solution is that the latter possessed much lower μ in the BL and mixed lubrication regimes, suggesting high effectiveness of the micelles as friction modifier. In the ELH regime, all three samples possessed a similar μ, as expected for dilute polymer solutions with viscosities similar to that of the base oil.

The high effectiveness in friction reduction in the BL regime was also demonstrated by the P(EXA-tBA)-PCEA solution. In this case, a strikingly impressive 95% reduction in μ was achieved at low U's with the addition of only ˜0.5 wt % of the diblock. Aside from this, the Stribeck-like curve of P(EXA-tBA)-PCEA appears different from that of P(EXA-tBA)-PHEA. The system seems to enter the BL at U≈500 mm/s, where the Stribeck curve peaked. Surprisingly, μ decreases sharply with decreasing U instead of being a constant as U decreased below ˜500 mm/s. This trend is obeyed by all PCEA-containing diblocks.

Performance Comparison of PCEA-Free Diblocks. FIG. 8 compares the Stribeck-like curves of solutions of P(EXA-tBA)-PHEA and P(EXA-tBA)-PAOEA micelles. Although the effectiveness of P(EXA-tBA)-PAOEA as a friction modifier is decreased relative to P(EXA-tBA)-PHEA, a drastic friction reduction effect is still seen of P(EXA-tBA)-PAOEA relative to the base oil data of FIG. 7. Furthermore, the shape of the two curves bears similar but not exact trends.

Such diblock lubrication behavior has been found for both graft copolymers dissolved in water as friction modifier (see (i) Lee, S.; Muller, M.; Ratoi-Salagean, M.; Voros, J.; Pasche, S.; De Paul, S. M.; Spikes, H. A.; Textor, M.; Spencer, N. D. Tribology Letters 2003, 15, 231 and (ii) Muller, M.; Lee, S.; Spikes, H. A.; Spencer, N. D. Tribology Letters 2003, 15, 395) or diblocks dissolved in oil as friction modifier (Muller, M.; Topolovec-Miklozic, K.; Dardin, A.; Spikes, H. A. Tribology Transactions 2006, 49, 225 and Dardin, A.; Muller, M.; Eisenberg, B. Lubricating oil Composition with Good Friction Characteristics. DE10314776, 2004).

While not wishing to be bound by any theory or mode of action it is believed that an explanation for such diblock behavior is that such diblocks with a solvent-insoluble block and a solvent-soluble block formed a brush layer on each of the mating surfaces. The polymer brushes help entrap engine oil and increases oil film thickness. The brushes reduce friction also for the inherent repulsion between them due to the osmotic force effect—see: (i) Klein, J.; Kumacheva, E.; Mahalu, D.; Perahia, D.; Fetters, L. J. Nature 1994, 370, 634; (ii) Klein, J. Annual Review Of Materials Science 1996, 26, 581, and (iii) Dai, L. L.; Granick, S. J. Polym. Sci. B: Polym. Phys. 2005, 43, 3487. It is believed that the P(EXA-tBA)-PHEA diblock functioned as a better friction modifier than P(EXA-tBA)-PAOEA because the PHEA block is more polar than the PAOEA block and adsorbs better to steel surfaces. A stronger binding block probably led to a denser and thus thicker brush layer.

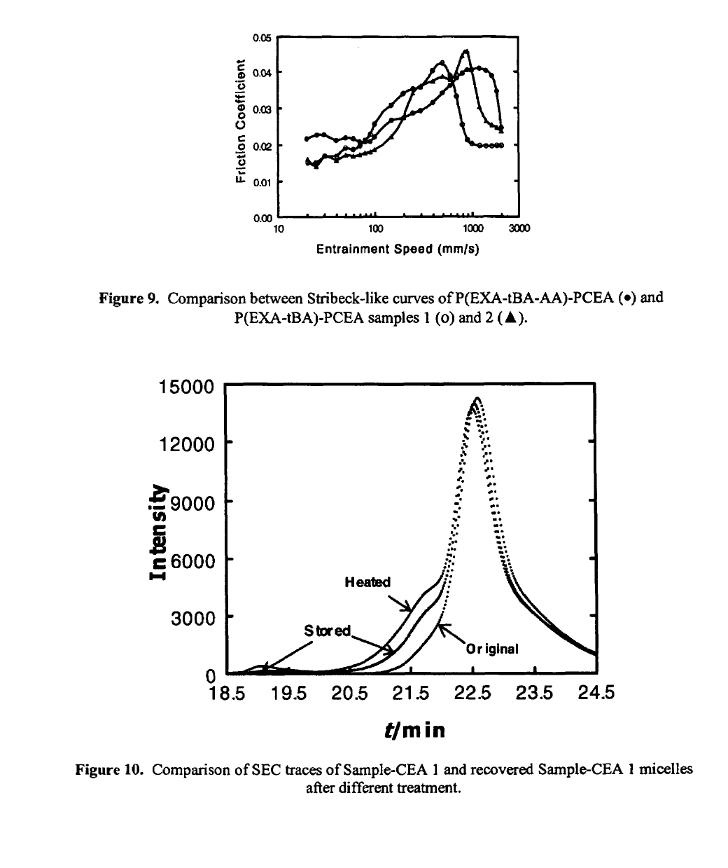

Performance Comparison of PCEA-Containing Diblocks. FIG. 9 compares the Stribeck-like curves of micellar solutions of Sample-CEA 1 (P(EXA-tBA)-PCEA with n=380, m=270, y=0.5%), Sample-AA-1 (derived from Sample-CEA 1 containing 0.1 mol % of AA groups), and Sample-CEA 2 (P(EXA-tBA)-PCEA with n=360 and m=430) obtained about 10 days after their preparation. All of the curves bear a similar shape. The fact that the peaks have a similar height is indicative that all three micellar solutions are highly effective in reducing friction between steel components.

It is further noted that the peak maximum for Sample-CEA 2 solution occurred at an entrainment speed of ˜900 mm/s, which is higher than that for the Sample-CEA 1 solution at ˜500 mm/s. The peak maximum for the P(EXA-tBA-AA)-PCEA or Sample-AA 1 data shifted to an entrainment speed of ˜1200 mm/s, which is higher even than that of the Sample-CEA 2 peak.

While not wishing to be bound by any particular theory or mode of action, it is believed that the lubrication data in FIG. 9 is characteristic of friction reduction caused by nanoparticles that get entrapped mechanically between two mostly rolling surfaces (vs. sliding) when the base oil film thickness gets comparable to or less than the particle diameter. The entrapped particles reduce friction because they prevent the further substantial decrease in the gap between the surfaces and help sustain the load. It is believed that such a mechanism is operative here because the lubrication tests were performed at a slide to rolling ratio as described above.

According to elastohydrodynamic lubrication theory (Hamrock, B. T.; Dowson, D., Ball Bearing Lubrication: The Elestohydrodynamics of Elliptical Contacts. John Wiley: New York, 1981), logarithm of thickness λ of an oil film entrapped between two moving surfaces lubricated by a base oil or log λ should decrease linearly with log U down to a λ value of ˜2 nm. For Sample-CEA 2 micelles with a larger TEM core diameter of 44±5 nm, this should lead to a larger critical λ or U value below which the particles get entrapped and the systems starts to enter the mixed lubrication regime, which is characterized by an abrupt increase in μ with decreasing U. A close look at FIG. 9 reveals that this is indeed the case and the Sample-CEA 2 system entered the mixed lubrication regime earlier than the Sample-CEA 1 system, where the Sample-CEA 1 micelles possess a smaller d_{TEM} of 33±6 nm.

It is surprising that the Sample-AA 1 system with d_{TEM}=37±5 nm entered the mixed lubrication regime earlier than Sample-CEA 2. It is believe that this was most likely caused by the aggregation of the P(EXA-tBA-AA)-PCEA micelles for the insolubility of the AA groups in the base oil, a fact that has been proven by us from a light scattering study where the hydrodynamic diameter of crosslinked P(EXA-tBA-AA)-PCEA micelles was shown to increase with AA content. Such aggregation can be seen also by the naked eye at higher AA contents, e.g., at 0.5 mol %, when the aggregated Sample-AA 1 micelles precipitated from the EHC-45 oil eventually with time.

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. It is therefore contemplated that the appended claims will cover any such modifications or embodiments.

All publications, patents and patent applications referred to herein are incorporated by reference in their entirety to the same extent as if each individual publication, patent or patent application was specifically and individually indicated to be incorporated by reference in its entirety.

1. An oil-dispersible nanoparticle comprising an organic polymer and polar metal-binding functional groups on its surface.

2. The nanoparticle defined in claim 1, wherein the average hydrodynamic diameter of the nanoparticle ranges from about 20 to about 250 nm, preferably about 20 to about 100 nm.

3. The nanoparticle defined in claim 1 comprising a core that is substantially insoluble in oil, and a corona that is oil soluble.

4. The nanoparticle defined in claim 3, wherein the diameter of the core ranges from about 10 to about 150 nm, and is preferably between about 10 to about 80 nm.

5. The nanoparticle defined in claim 3, wherein the core is crosslinkable, optionally photo-crosslinkable.

6. The nanoparticle of defined in claim 1, which is substantially spherical or cylindrical.

7. The nanoparticle defined in claim 1, derived from the following chemical structure: 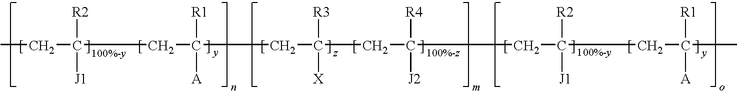
wherein:
R1, R2, R3 and R4 are independently hydrogen or a C₁-C₆ alkyl group;
J1 and J2 are the same or different and each is an alkylphenyl group or alkylcarboxyl group;
A is an anchoring or hook group;
X is a cross-linkable oil insoluble moiety;
y is 0 to 30%;
z is 5 to 100%;
m and n are the same or different and each is an integer in the range of 10 to 10,000; and
o is an integer in the range of 0 to 10,000.

8. The nanoparticle defined in claim 7, wherein R1, R2, R3 and R4 are independently hydrogen or a methyl group.

9. The nanoparticle defined in claim 7, wherein R1, R2, R3 and R4 each are hydrogen.

10. The nanoparticle defined in claim 7, wherein the alkyl groups in J1 can be either linear or branched and have 1 to 30 carbon atoms.

11. The nanoparticle defined in claim 7, wherein the alkyl groups in J1 can be either linear or branched and have 4 to 18 carbon atoms.

12. The nanoparticle defined in claim 7, wherein the alkyl groups in J1 can be either linear or branched and have 6 to 10 carbon atoms.

13. The nanoparticle defined in claim 7, wherein the alkyl groups in J2 can be either linear or branched and have 1 to 30 carbon atoms.

14. The nanoparticle defined in claim 7, wherein the alkyl groups in J2 can be either linear or branched and have 1 to 10 carbon atoms.

15. The nanoparticle defined in claim 7, wherein the alkyl groups in J2 can be either linear or branched and have 1 to 6 carbon atoms.

16. The nanoparticle defined in claim 7, wherein A is selected from the group consisting of hydroxyl, amino, carboxyl, carboxyphenyl (where the carboxyl group can be at the para, meta, or ortho position, pyridyl, aminoalkylphenyl, carboxyalkylphenyl, N-alkylcarbamoyl, N,N-dialkylcarbamoyl, glycerylcarboxyl, hydroxyalkylcarboxyl, imidazolyl, and triazolyl

17. The nanoparticle defined in claim 7, wherein X is selected from the group consisting of hydroxyl, amino, carboxyl, carboxyphenyl (where the carboxyl group can be at the para, meta, or ortho position), pyridyl, aminoalkylphenyl, carboxyalkylphenyl, glycerylcarboxyl, hydroxyalkylcarboxyl, cinnamoyloxyalkylcarboxyl, allylcarboxyl, and acryloxyalkylcarboxyl.

18. The nanoparticle defined in claim 7, wherein X selected from the group consisting of carboxyl groups, amino groups, pyridyl groups, carbonyl groups, hydroxyl groups, sulfonyl groups, sulfate groups, phosphine groups, phosphate groups and sulfide groups.

19. The nanoparticle defined in claim 13, wherein X selected from the group consisting of carboxyl groups, amino groups, pyridyl groups, carbonyl groups, hydroxyl groups, sulfonyl groups, sulfate groups, phosphine groups, phosphate groups and sulfide groups.

20. The nanoparticle defined in claim 7, wherein m and n are the same or different and each is an integer in the range of 10 to 500.

21. The nanoparticle defined in claim 7, wherein m and n are the same or different and each is an integer in the range of 10 to 500.

22. The nanoparticle defined in claim 7, wherein o is an integer in the range of 0 to 500.

23. A method for making an oil-dispersible nanoparticle comprising 1) forming substantially spherical micelles of (A_{100%-y}C_{y})ₙBₘ diblocks or (A_{100%-y}C_{y})ₙBₘ(A_{100%-y}C_{y})ₙ triblocks in a block-selective solvent and, optionally, 2) crosslinking the substantially spherical micelles,
where the A units are oil soluble monomers; the C units are functional groups that are metal binding or metal binding after chemical transformation; and the B units are oil insoluble monomers and preferably crosslinkable;
where y ranges from 0 to about 30% and preferably from about 0.1% to about 2%;
where n ranges from about 10 to about 10,000; and
where m ranges from about 10 to about 10,000.

24. The method defined in claim 23, wherein the A is selected from poly(alkyl acrylate), poly(alkyl methacrylate), poly(dimethyl siloxane), polyisoprene, poly(butadiene), poly(isobutylene), polystyrene, poly(alkylstyrene) and combinations thereof.

25. The method defined in claim 23, wherein the alkyl units are selected from C₁ to C₂₀.

26. The method defined in claim 23, wherein the alkyl units are selected from C₄ to C₁₈.

27. The method defined in claim 23, wherein the alkyl units are butyl, 2-ethylhexyl or a combination thereof.

28. The method defined in claim 23, wherein the C units are selected to contain carboxyl groups, amino groups, pyridyl groups, carbonyl groups, hydroxyl groups, sulfonyl groups, sulfate groups, phosphine groups, phosphate groups, sulfide groups, triazole groups, indole groups and combinations thereof.

29. The method defined in claim 23, wherein B is selected from poly(vinyl pyridine), poly(2-cinnamoyloxyethyl methacrylate), poly(2-cinnamoyloxyethyl acrylate), poly(2-hydroxyethyl acrylate), poly(2-hydroxyethyl methacrylate), polyisoprene, polybutadiene, poly[2-(dimethylamino)ethyl methacrylate], poly(acrylic acid), poly(methacrylic acid), poly(vinyl alcohol), poly[ally(meth)acrylate], poly[acryloxyethyl(meth)acrylate] and combinations thereof.

30. A method of reducing friction comprising providing an oil-dispersible nanoparticle of claim 1 as an additive to an oil employed for lubrication.

31. A method of reducing wear of machine parts comprising providing an oil-dispersible nanoparticle of claim 1 as an additive of an oil contacting said machine parts.

32. An oil composition comprising the nanoparticle defined in claim 1 and a base oil composition.
